(19) United States
(12) Patent Application Publication
(10) Pub. No.: US 2013/0041851 A1
(43) Pub. Date: Feb. 14, 2013

(54) IMPLEMENTING DIRECT ENERGY METERING, AUTHENTICATION AND USER BILLING

(71) Applicant: David M. Judkovics, Endicott, NY (US)

(72) Inventor: David M. Judkovics, Endicott, NY (US)

(73) Assignee: INTERNATIONAL BUSINESS MACHINES CORPORATION, Armonk, NY (US)

(21) Appl. No.: 13/206,721

(22) Filed: Aug. 10, 2011

(51) Int. Cl. G06Q 30/00

(52) U.S. Cl. 705/412

(57) ABSTRACT

A method, computer program product, and an intelligent circuit breaker are provided for implementing authentication, direct energy metering, and user billing for an electric vehicle owner. The intelligent circuit breaker is configured to be received within a conventional circuit breaker power panel without requiring infrastructure modification of the power panel. The intelligent circuit breaker communicates with an electric vehicle and a billing service, establishing user authentication, enables charging, performs direct electrical energy metering, and sends billing information to the billing service.

### FIELD OF THE INVENTION

The present invention relates generally to the data processing field, and more particularly, relates to a method, computer program product, and an intelligent circuit breaker for implementing authentication, direct energy metering, and user billing for an electric vehicle owner.

### DESCRIPTION OF THE RELATED ART

With the proliferation of electric vehicles that require charging the need arises for the ability to deliver and bill for metered electricity. Technology exists in the form of new point of sale charging systems that are expensive and labor intensive to install.

A need exists for an efficient and effective mechanism to rapidly and economically provide pay charging access points for electric vehicles at minimum cost and infrastructure modification.

As used in the following description and claims, the term electric vehicle should be broadly understood to generally include various electric devices requiring charging.

### SUMMARY OF THE INVENTION

Principal aspects of the present invention are to provide a method, computer program product, and an intelligent circuit breaker for implementing authentication, direct energy metering, and user billing for an electric vehicle owner. Other important aspects of the present invention are to provide such method, computer program product, and intelligent circuit breaker substantially without negative effects and that overcome many of the disadvantages of prior art arrangements.

In brief, a method, computer program product, and an intelligent circuit breaker are provided for implementing authentication, direct energy metering, and user billing for an electric vehicle owner. The intelligent circuit breaker is configured to be received within a conventional circuit breaker power panel without requiring infrastructure modification of the power panel. The intelligent circuit breaker communicates with an electric vehicle and a billing service, establishing user authentication, enables charging, performs direct electrical energy metering, and sends billing information to the billing service.

In accordance with features of the invention, the intelligent circuit breaker enables rapidly, efficiently and effectively providing pay charging access points for electric vehicles at minimal cost and with minimal infrastructure modification.

In accordance with features of the invention, the intelligent circuit breaker functions as a single replacement circuit breaker without requiring additional infrastructure changes within the circuit breaker power panel. The intelligent circuit breaker is capable of metering power supplied, and has billing capability, and customer authentication capability.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram physical representation of an example system including an electric vehicle and conventional commercial and residential wiring together with an intelligent circuit breaker in accordance with the preferred embodiment;

FIG. 2 is a more detailed block diagram system view of the system including the electric vehicle and conventional commercial and residential wiring together with the intelligent circuit breaker of FIG. 1 in accordance with the preferred embodiment;

FIG. 3 is a flow chart illustrating exemplary operations for implementing authentication, direct energy metering, and user billing for an electric vehicle owner in the system of FIGS. 1 and 2 in accordance with the preferred embodiment; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method, computer program product, and an intelligent circuit breaker are provided for implementing authentication, direct energy metering, and user billing for an electric vehicle owner.

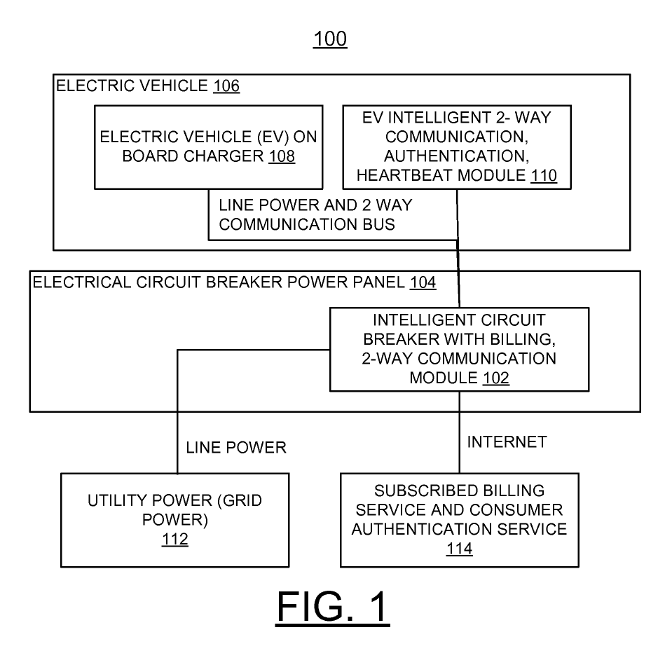

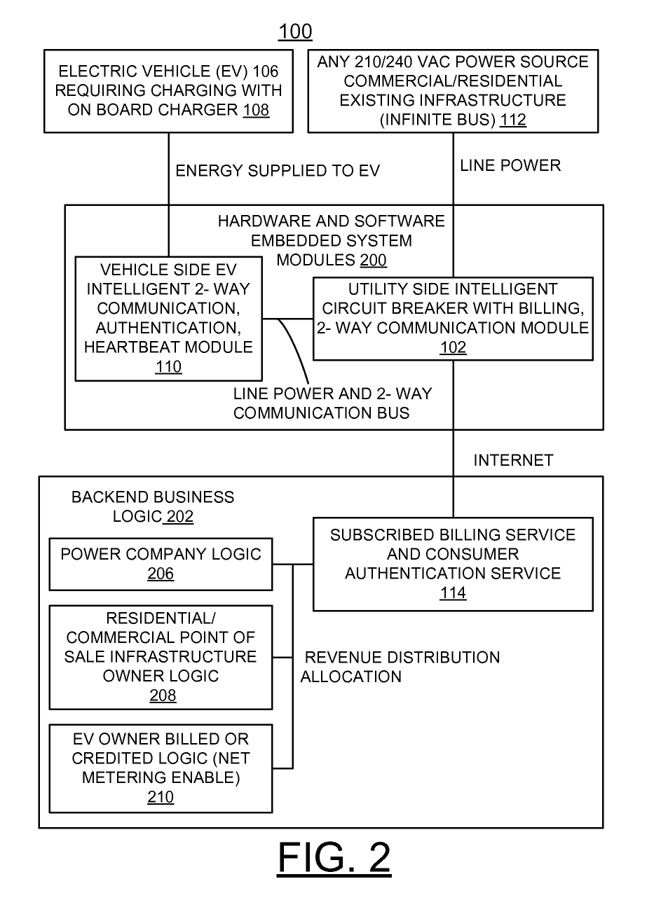

Having reference now to the drawings, in FIGS. 1 and 2, there is shown an example system generally designated by the reference character 100 for implementing authentication, direct energy metering, and user billing for an electric vehicle owner in accordance with the preferred embodiment. System 100 relies upon conventional commercial and residential wiring used with an intelligent circuit breaker 102 received within an electrical circuit breaker power panel 104. The intelligent circuit breaker 102 integrally includes a billing and 2-way communication module in accordance with the preferred embodiment.

System 100 includes an electric vehicle 106 including an electric vehicle (EV) on board charger 108 and an EV intelligent 2-way communication, authentication, heartbeat module 110. The electric vehicle 106 and the intelligent circuit breaker 102 communicate over a line power and 2-way communication bus, as shown. The line power and 2-way communication bus comprises existing conventional power line infrastructure, including a power cable connecting the circuit breaker 102 within the power panel 104 to an outlet connected to the electric vehicle 106. The intelligent circuit breaker 102 is connected to utility power or grid power 112 as indicated at line labeled LINE POWER, and is connected via the Internet to a subscriber billing service and consumer authentication service 114.

In accordance with features of the invention, the intelligent circuit breaker 102 enables rapidly and economically providing pay charging access points for electric vehicles at minimum cost and infrastructure modification. The intelligent circuit breaker 102 is configured with the appropriate form factor to be used in existing power panels 108. The intelligent circuit breaker 102 functions as a single replacement circuit breaker without requiring additional infrastructure changes. The intelligent circuit breaker 102 is capable of directly metering electrical energy power supplied, and has billing capability and customer authentication capability.

Referring to FIG. 2, hardware and software embedded system modules 200 of the system 100 include the utility side intelligent circuit breaker 102 with the integral billing and 2-way communication module and the vehicle side EV intelligent 2-way communication, authentication, heartbeat module 110 connected by the line power and 2-way communications bus. Associated with the subscriber billing service and consumer authentication service 114 are backend business logic 202 including power company logic 206, residential and commercial point of sale infrastructure owner logic 208, and EV owner billed or credited logic 210 with net metering enable. The backend business logic 202 is coupled to the subscriber billing service and consumer authentication service 114 for revenue distribution and allocation, as illustrated.

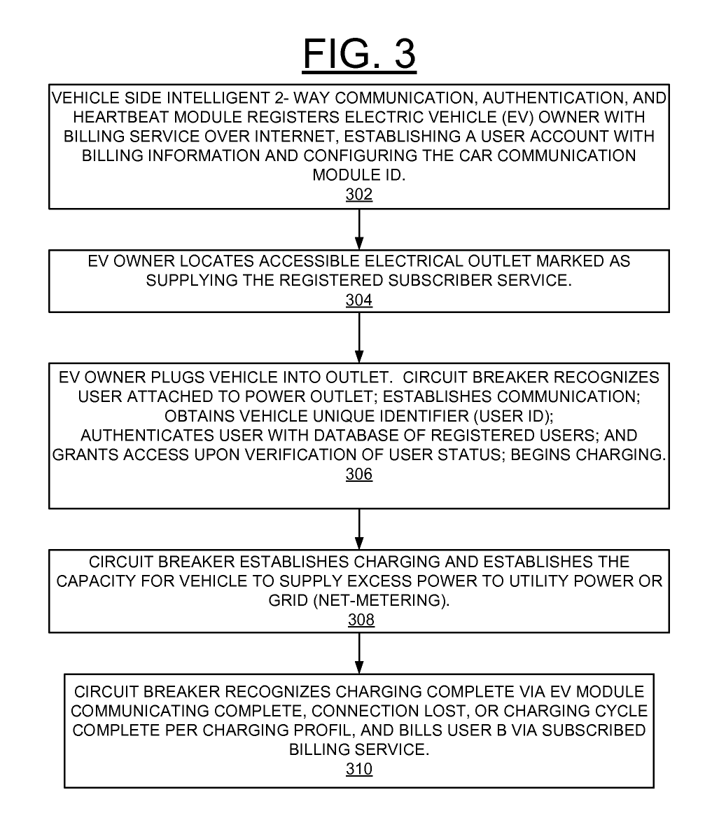

Referring to FIG. 3, there are shown exemplary operations for implementing authentication, direct energy metering, and user billing for an electric vehicle owner in the system 100 of FIGS. 1 and 2 in accordance with the preferred embodiment. The vehicle side EV intelligent 2-way communication, authentication, heartbeat module 110 registers with billing service 114 over the internet, establishing a user account with billing information and configuring the in car communication module ID as indicated at a block 302. As indicated at a block 304, once established EV owner finds an accessible electrical outlet, for example, in a parking garage, municipal lot, public or private building, marked as supplying the registered subscriber service.

As indicated at a block 306, the EV owner plugs vehicle into outlet; the circuit breaker 102 recognizes the connection with the user attaching to the power outlet, establishes communication, obtains vehicle unique identifier or user ID from in car module, authenticates user with the database of registered users; and grants access upon verification of user status, and begins charging. The circuit breaker 102 establishes charging and likewise the capacity for vehicle to supply excess power to grid (net-metering) as indicated at a block 308. The circuit breaker 102 recognizes charging complete via EV module communicating complete, connection lost, or charging cycle complete per charging profile and bills the user via subscribed billing service as indicated at a block 310.

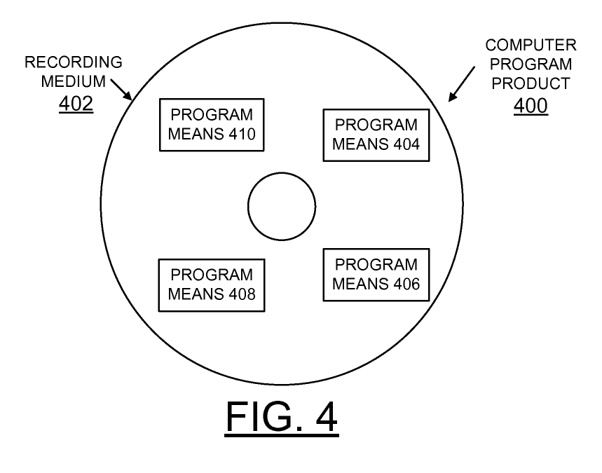

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, or another similar computer program product. Recording medium 402 stores program means 404, 406, 408, 410 on the medium 402 for carrying out the methods for implementing authentication, direct energy metering, and user billing for an electric vehicle owner of the preferred embodiment in the utility side intelligent circuit breaker 102 with the billing and 2-way communication module and the vehicle side EV intelligent 2-way communication, authentication, heartbeat module 110 of the hardware and software embedded system modules 200 of FIG. 2.

A sequence of program instructions or a logical assembly of one or more interrelated modules defined by the recorded program means 404, 406, 408, 410, direct the hardware and software embedded system modules 200 for carrying out the methods of the preferred embodiment.

While the present invention has been described with reference to the details of the embodiments of the invention shown in the drawing, these details are not intended to limit the scope of the invention as claimed in the appended claims.

What is claimed is:

1. A method for implementing authentication, direct energy metering, and user billing for an electric vehicle owner comprising:
installing an intelligent circuit breaker within an available circuit breaker power panel;
said intelligent circuit breaker communicating with an electric vehicle and a billing service;
said intelligent circuit breaker establishing user authentication, enabling charging, performing direct electrical energy metering, and sending billing information to the billing service.

2. The method as recited in claim 1 wherein said intelligent circuit breaker communicating with the electric vehicle and the billing service includes providing a intelligent communication module in both said intelligent circuit breaker and said electric vehicle, and connecting said intelligent circuit breaker and said electric vehicle with a line power and communications bus.

3. The method as recited in claim 1 wherein said intelligent circuit breaker communicating with the electric vehicle includes providing an intelligent communication module in said intelligent circuit breaker; and said intelligent communication module in said intelligent circuit breaker communicating with said billing service via an Internet connection.

4. The method as recited in claim 1 wherein said intelligent circuit breaker establishing user authentication includes said intelligent circuit breaker obtaining a vehicle unique user identifier and authenticating the user with a database of registered users in the billing service.

5. The method as recited in claim 4 wherein said intelligent circuit breaker enables charging of the electric vehicle responsive to authenticating the user.

6. The method as recited in claim 5 wherein said intelligent circuit breaker performs direct electrical energy metering responsive to enabling charging of electric vehicle.

7. The method as recited in claim 1 wherein said intelligent circuit breaker sending billing information to the billing service includes said intelligent circuit breaker sending billing information to the billing service responsive to recognizing charging complete.

8. The method as recited in claim 1 wherein installing said intelligent circuit breaker within the available circuit breaker power panel includes configuring said intelligent circuit breaker with a predefined form factor for use in the available circuit breaker power panel.

9. A computer program product for implementing authentication, direct energy metering, and user billing for an electric vehicle (EV) owner in hardware and software embedded system modules including an intelligent communication module in an intelligent circuit breaker and an EV intelligent communication, authentication, heartbeat module, said computer program product tangibly embodied in a non-transitory machine readable medium, said computer program product including instructions executed by the hardware and software embedded system modules to cause the hardware and software embedded system modules to perform the steps comprising:
said intelligent circuit breaker communicating with an electric vehicle and a billing service;
said intelligent circuit breaker establishing user authentication, enabling charging, performing direct electrical energy metering, and sending billing information to the billing service.

10. The computer program product as recited in claim 9 wherein said intelligent circuit breaker communicating with the electric vehicle and the billing service includes connecting said intelligent circuit breaker and said electric vehicle with a line power and communications bus.

11. The computer program product as recited in claim 9 wherein said intelligent circuit breaker communicating with the electric vehicle and the billing service includes said intelligent communication module in said intelligent circuit breaker communicating with said billing service via an Internet connection.

12. The computer program product as recited in claim 9 wherein said intelligent circuit breaker establishing user authentication includes said intelligent circuit breaker obtaining a vehicle unique user identifier and authenticating the user with a database of registered users in the billing service.

13. The computer program product as recited in claim 12 wherein said intelligent circuit breaker enables charging of the electric vehicle responsive to authenticating the user.

14. The computer program product as recited in claim 13 wherein said intelligent circuit breaker performs direct electrical energy metering responsive to enabling charging of the electric vehicle.

15. The computer program product as recited in claim 9 wherein said intelligent circuit breaker sending billing information to the billing service includes said intelligent circuit breaker sending billing information to the billing service responsive to recognizing charging complete.

16. An intelligent circuit breaker for implementing authentication, direct energy metering, and user billing for an electric vehicle owner comprising:
a predefined form factor configured for use in an available circuit breaker power panel receiving said intelligent circuit breaker;
said intelligent circuit breaker including an intelligent communication module communicating with an electric vehicle and a billing service;
said intelligent communication module of said intelligent circuit breaker establishing user authentication, enabling charging, performing direct electrical energy metering, and sending billing information to the billing service.

17. The intelligent circuit breaker as recited in claim 16 wherein said intelligent communication module of said intelligent circuit breaker is connected to said electric vehicle with a line power and communications bus.

18. The intelligent circuit breaker as recited in claim 16 wherein said intelligent communication module of said intelligent circuit breaker is connected to the billing service via an Internet connection.

19. The intelligent circuit breaker as recited in claim 16 wherein said intelligent communication module of said intelligent circuit breaker establishing user authentication includes said intelligent communication module of said intelligent circuit breaker obtaining a vehicle unique user identifier and authenticating the user with a database of registered users in the billing service.

20. The intelligent circuit breaker as recited in claim 16 wherein said intelligent communication module of said intelligent circuit breaker sending billing information to the billing service includes said intelligent communication module of said intelligent circuit breaker sending billing information to the billing service responsive to recognizing charging complete.
